(19) United States
(12) Patent Application Publication
(10) Pub. No.: US 2011/0248912 A1
(43) Pub. Date: Oct. 13, 2011

(54) DISPLAY DEVICE HAVING THE CONNECTION INTERFACE WITH ILLUMINING AND INDICATING FUNCTIONS

(76) Inventor: Chien-Chou Chen, Taipei County (TW)

(21) Appl. No.: 12/953,411

(22) Filed: Nov. 23, 2010

(30) Foreign Application Priority Data
Apr. 12, 2010 (TW) 099111328

(51) Int. Cl. G09G 5/00

(52) U.S. Cl. 345/156

(57) ABSTRACT

A display device includes a connection interface and a light source. The light source illuminates the connection interface and indicates I/O ports of the connection interface. The light source can illuminate all I/O ports of the connection interface or the I/O port of the connection interface corresponding to the input signal source selected by the user.

### BACKGROUND OF THE INVENTION

1. Field of the Invention

The present invention relates to a display device, and more particularly, to a display device having the connection interface with illumining and indicating functions.

2. Description of the Prior Art

General display devices, such as television sets or computer monitors, have video or audio connection interface so that users can connect external video or audio devices to the display devices. The connection interface includes different types of input/output (I/O) ports, such as high-definition multimedia interface (HDMI) port, video graphics array (VGA) port, Sony/Philips Digital Interconnect Format (S/PDIF) port, composite video port or component video port. Normally the connection interface of the display device is located at the rear, lateral, bottom, or lower section of the front side of the display device, and the connection interface has corresponding labels of different types of I/O ports for identification.

Since the display device is mostly set close to the wall, the user needs to move the display device in order to connect the signal wire to the connection interface when connecting the external video or audio devices to the display device. However, the space between the display device and the wall may be very limited, and this causes insufficient light around the connection interface, so the user can hardly identify the labels of the connection interface. Although each type of the video or audio I/O ports can only be connected to a specific type of signal wire, the user still has to find the location of the I/O port so as to properly connect the signal wire to the corresponding port. In addition, there could be more than two I/O ports which are the same type, so the user needs to switch the signal source of the display device to the correct port in order to properly receive or output the audio or video signals. Thus, the existed connection interface of display device in prior arts is very inconvenient to the user.

### SUMMARY OF THE INVENTION

The present invention provides a display device, comprising a connection interface, alight source, and a signal generating device. The connection interface comprises a plurality of I/O ports. The light source is located close to the connection interface, for illuminating the connection interface. The signal generating device is electrically connected to the light source, for generating a state signal. The light source indicates the connection interface to a user according to the state signal.

The present invention further provides a display device, comprising a plurality of I/O ports, a plurality of light sources, and a signal generating device. The plurality of light sources is located close to the I/O ports, each light source illuminating the corresponding I/O port respectively. The signal generating device is electrically connected to the plurality of light sources, for generating a state signal. Part of the plurality of light sources is illuminated according to the state signal and thus part of the plurality of I/O ports is indicated to the user correspondingly.

The present invention further provides a method of indicating a connection interface of a display device to a user, comprising the steps of: generating a state signal according to the user; illuminating a light source of the display device according to the state signal, said light source is located close to the connection interface; and turning off the light source of the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an enlarged view of the first embodiment of the display device according to the present invention.

FIG. 2 is a schematic view of the second embodiment of the display device according to the present invention.

FIG. 3 is a schematic view of the third embodiment of the display device according to the present invention.

FIG. 4 is a schematic view of the fourth embodiment of the display device according to the present invention.

FIG. 5 is a schematic view of the fifth embodiment of the display device according to the present invention.

### DETAILED DESCRIPTION

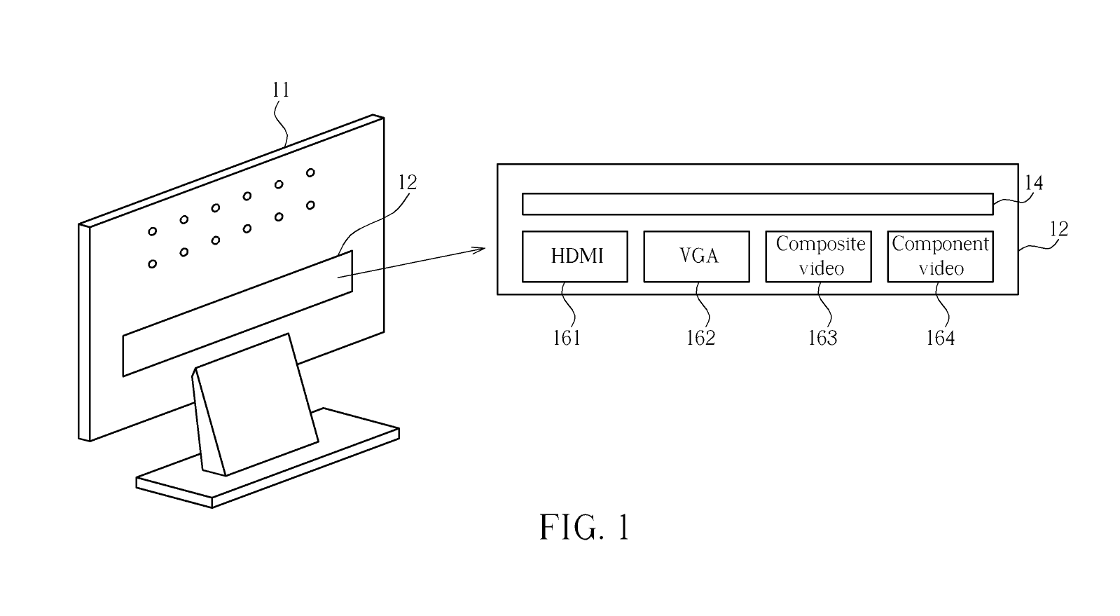

Please refer to FIG. 1. FIG. 1 is an enlarged view of the first embodiment of the present invention. A display device 11 comprises a connection interface 12 and a light source 14. The connection interface may be located on the back or lateral of the display device. For example, as shown in FIG. 1, the connection interface is located at the back of the display device 11. The connection interface 12 comprises a plurality of video and audio I/O ports, such as HDMI port 161, VGA port 162, composite video port 163, and component video port 164. Although each type of the video or audio I/O ports can only be connected to a specific type of signal wire, the user still has to identify the labels for some I/O ports. For example, the user has to connect the Y, Pb/Cb, and Pr/Cr connectors of the signal wire to the Y, Pb/Cb, and Pr/Cr ports of the component video port 164 respectively. Since the connection interface 12 is located at the back of the display device 11, the light is insufficient around the connection interface 12, and this causes that the user can hardly identify the labels of the connection interface 12. Thus, by the illumination of the light source 14, the user can identify the labels of the connection interface 12 clearly, and connect the signal wire to the corresponding I/O port correctly. The light source 14 can comprise any illuminating device. For example, the light source 14 is a light-emitting diode (LED) module.

In addition, in another embodiment, there is an opening on the rear of the backlight module of the display device, so the light beam generated by the backlight module can pass through the opening and further form the light source 14 illuminating the connection interface 12 by a light guide device.

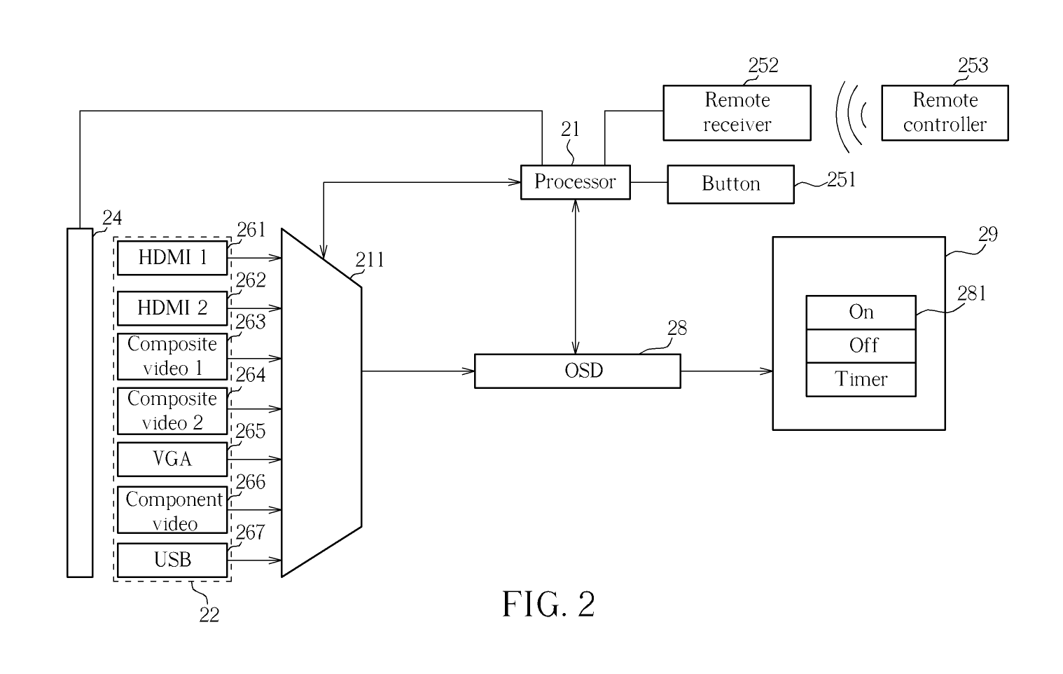

Please refer to FIG. 2. FIG. 2 is a schematic view of the second embodiment of the present invention. A display device comprises a processor 21, a multiplexer 211, a connection interface 22, a light source 24, and an on screen display (OSD) menu generator 28. Usually the display device comprises a plurality of video and audio I/O ports which are several types, and more than two I/O ports may be the same type. In this embodiment, the connection interface 22 comprises HDMI1 port 261, HDMI2 port 262, composite video port1 263, composite video port2 port 264, VGA port 265, component video port 266, and USB port 267. The processor 21 can control the multiplexer 211 selecting an input signal from the connection interface 22 and display the input signal on the screen 29.

The processor 21 further communicates with the OSD menu generator 28 for generating an OSD menu 281 on the screen 29. The user can configure the state of the light source 24 from the OSD menu 281. The user can use the button 251 on the display device or the remote controller 253 to select the I/O illumination options of the OSD menu 281, the processor 21 then controls the light source 24 according to the state configured by the user. When the user operates the remote controller 253, the remote receiver 252 receives the signals from the remote controller 253 through infrared rays or Bluetooth. The I/O illumination options of the OSD menu 281 comprise turn-on, turn-off, and timer. When the turn-on option of the I/O illumination is selected, the light source 24 is turned on and illuminating. When the turn-off option of the I/O illumination is selected, the light source 24 is turned off. When timer option of the I/O illumination is selected, the user can further set countdown time t of a timer or the timer is set as default by the display device. Then the light source 24 is turned on and will be turned off automatically after the timer runs out.

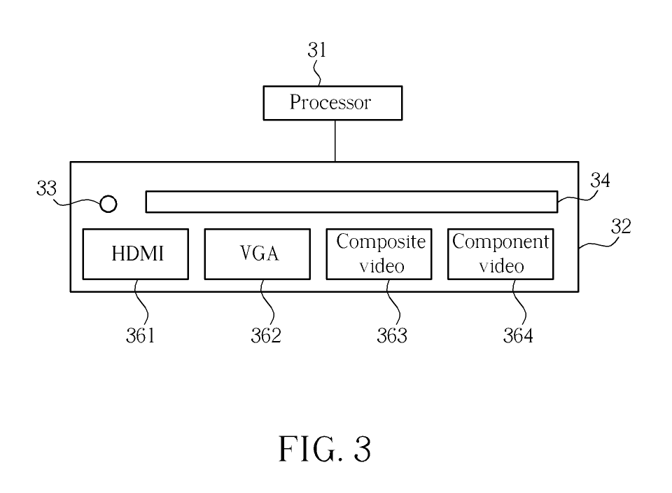

Please refer to FIG. 3. FIG. 3 is a schematic view of the third embodiment of the present invention. A display device comprises a processor 31, a connection interface 32, an object sensor 33, and a light source 34. The connection interface 32 comprises HDMI port 361, VGA port 362, composite video port 363, and component video port 364. In this embodiment, the processor 31 controls the light source 34 according to the object sensor 33, wherein the object sensor 33 comprises a proximity sensor or a contact sensor. When the object sensor 33 detects the presence of a nearby object, the processor 31 turns on the light source 34 according to the signal transmitted from the object sensor 33. On the other hand, after the object is certain distance away, the object sensor 33 will transmit the undetected signal to the processor, and the processor 31 will turn off the light source 34. In this way, when the user approaches the connection interface 32 for connecting the signal wire, the light source 34 is turned on automatically and providing the necessary illumination. When the user leaves the connection interface 32 after connecting the signal wire, the light source 34 is turned off automatically for saving power. According to another embodiment of the present invention, the display device comprises a plurality of light sources located close to the corresponding I/O ports, and a plurality of object sensors corresponding to the plurality of light sources. In this embodiment, the object sensors can turn on the corresponding light sources for illuminating the corresponding I/O ports.

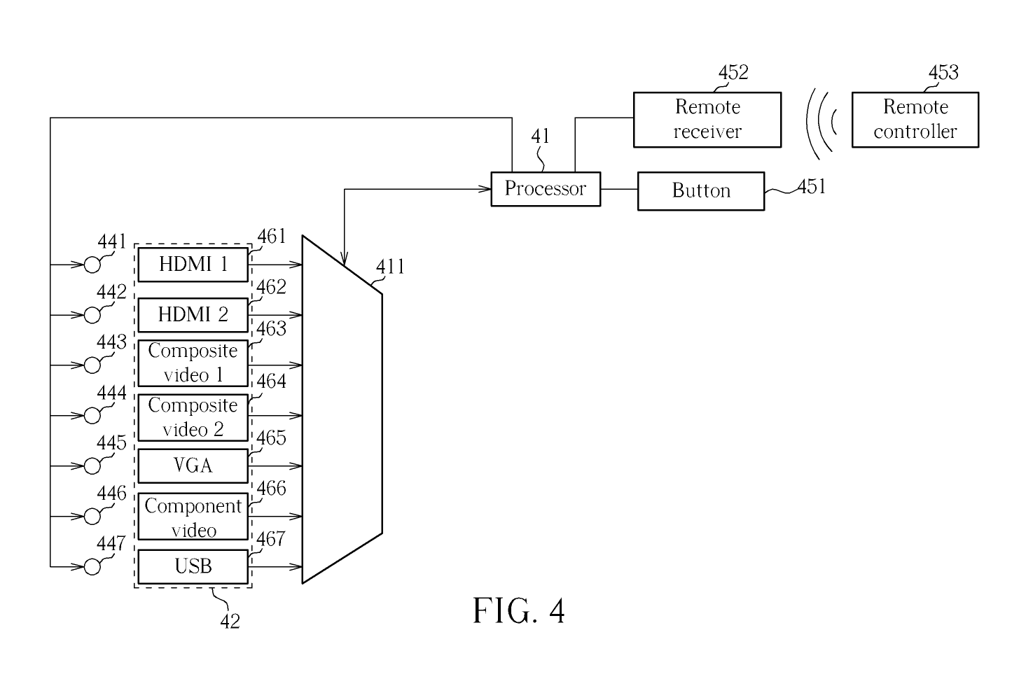

Please refer to FIG. 4. FIG. 4 is a schematic view of the fourth embodiment of the present invention. The display device comprises a processor 41, a multiplexer 411, a connection interface 42, and a plurality of light sources 441-447. The connection interface 42 comprises HDMI1 port 461, HDMI2 port 462, composite video port1 463, composite video port2 464, VGA port 465, component video port 466, and USB port 467. The plurality of light sources 441-447 is located close to the I/O ports 461-467 respectively and illuminates the corresponding I/O ports 461-467 individually. The user can select the input signal source of the display device through the button 451 on the display device or the remote controller 453. The remote controller 453 communicates with the remote receiver 452 through infrared rays or Bluetooth. When the user switches the input signal source of the display device, the processor 41 can select the input signal source from the I/O ports 461-467 of the connection interface 42 by the multiplexer 411 and turn on the corresponding light source of the I/O port which is the input signal source. Thus, the light sources 441-447 also indicate the corresponding I/O ports 461-467 to the user when the user is connecting the signal wire to the I/O port. For example, when the user switches the input signal source to HDMI2, the light source 442 corresponding to the HDMI2 port 462 is turned on, so the user can connect the signal wire to the HDMI2 port 462 correctly according to the indication of the light source 442. Moreover, the light source 441-447 could comprise groups of lights with any combination of colors, or illuminate in different ways, such as blink or flash, in order to indicate the corresponding I/O ports to the user. For example, the light source 446 could comprise a green light source, a blue light source, and a red light source, which indicates the Y, Pb/Cb, and Pr/Cr ports of the component video port 466. The light source 446 could also illuminate green light, blue light, and red light sequentially.

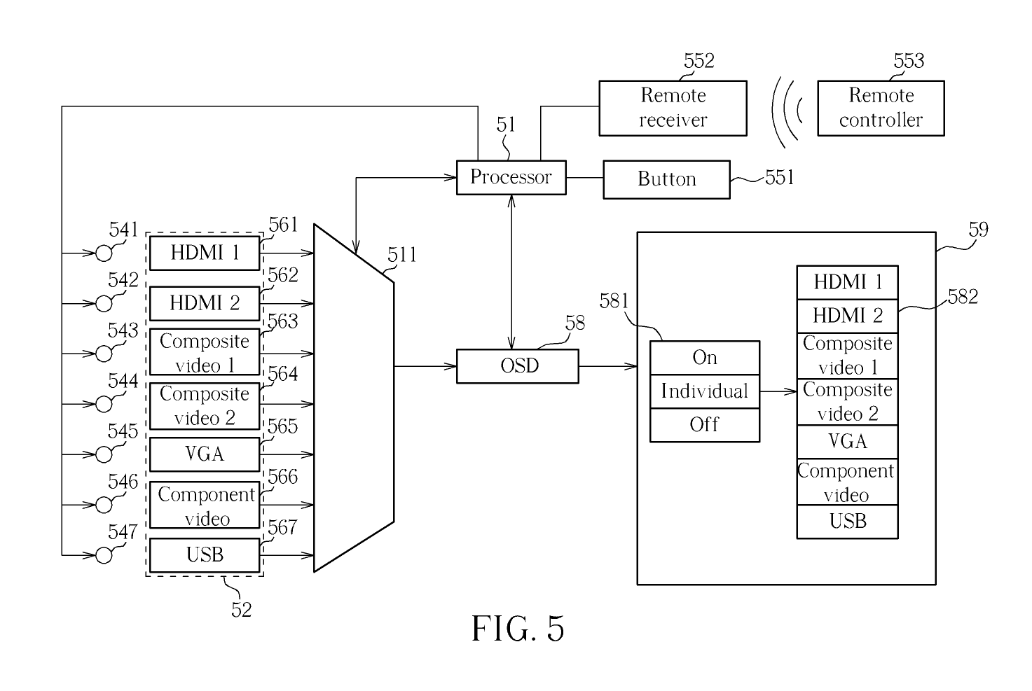

Please refer to FIG. 5. FIG. 5 is a schematic view of the fifth embodiment of the present invention. The display device comprises a processor 51, a multiplexer 511, a connection interface 52, a plurality of light sources 541-547, and an OSD menu generator 58. The connection interface 52 comprises HDMI1 port 561, HDMI2 port 562, composite video port1 563, composite video port2 564, VGA port 565, component video port 566, and USB port 567.

The processor 51 can select the input signal from the connection interface 52 by the multiplexer 511 and drive the OSD menu generator 58 to generate an OSD menu 581 on the screen 59, so the user can configure the states of the light sources 541-547 from the OSD menu 581. The user can use the button 551 on the display device or the remote controller 553 to select the I/O illumination options of the OSD menu 581, the processor 51 then controls the light source 541-547 according to the states configured by the user. When the user operates the remote controller 553, the remote receiver 552 receives the signals from the remote controller 553 through infrared rays or Bluetooth. The I/O illumination options of the OSD menu 581 comprise all turn-on, individual turn-on, and all turn-off. When the all turn-on option of I/O illumination is selected, the processor 51 turns on all of the light sources 541-547 for illuminating all I/O ports of the connection interface 52 so the user can identify the labels of the connection interface 52 clearly and connect the signal wire to the corresponding I/O port correctly. When the individual turn-on option of I/O illumination is selected, the OSD menu 581 shows a pop-up menu listing all I/O ports for further selection. The processor 51 then turns on the corresponding light source(s) corresponding to the I/O port(s) selected by the user, so the light source not only illuminates but also indicates the corresponding I/O port to the user when the user is connecting the signal wire to the connection interface. For example, when the user select the VGA port in the individual turn-on option of I/O illumination, the light source 545 corresponding to the VGA port 565 will be turned on, so that the user can connect the signal wire to the VGA port 565 according to the indication of the light source 545. The user can also select multiple I/O ports in the in the individual turn-on option of I/O illumination, and the light sources corresponding to the selected I/O ports will illuminate. When the all turn-off option of the I/O illumination is selected, the processor 51 turns off all of the light sources 541-547 for saving power.

In conclusion, the display device of the present invention comprises a connection interface and a light source which provide illumination to the connection interface and indicates I/O ports of the connection interface to the user. The light source can comprise any illuminating device, such as a LED module. The display device can further comprise a sensor which detects the presence of a nearby object, so the light source will be turned on automatically when the user try to connect the signal wire to the I/O port. The display device can also comprise more than one light source, and the light sources can be set as all illumination or individual illumination. All illumination means that the light source can illuminate all I/O ports of the connection interface, so the user can identify the labels of the connection interface clearly. Individual illumination means that the light source illuminates the I/O port corresponding to the selection made by the user, so the user can find the location of the I/O port according to the light source. In addition, the user can configure the light source as all illumination or individual illumination through the OSD menu, or turning off the light source for power saving.

Those skilled in the art will readily observe that numerous modifications and alterations of the device and method may be made while retaining the teachings of the invention.

What is claimed is:

1. A display device, comprising:
a connection interface, comprising a plurality of input/output (I/O) ports;
a light source, located close to the connection interface, for illuminating the connection interface; and
a signal generating device, electrically connected to the light source, for generating a state signal;
wherein the light source indicates the connection interface to a user according to the state signal.

2. The display device of claim 1, further comprising:
a processor, electrically connected to the light source, for controlling the light source.

3. The display device of claim 2, further comprising:
an OSD menu generator, for generating an OSD menu on the display device, the OSD menu for configuring turn-on, turn-off, and timer for the light source.

4. The display device of claim 2, wherein the signal generating device comprising:
an object sensor, electrically connected to the processor and located close to the connection interface, for detecting if an object comes close to the connection interface.

5. The display device of claim 1, further comprising:
a backlight module generating light beams;
wherein the light beams generated by the backlight module is guided to the light source.

6. The display device of claim 1, wherein the light source comprises an LED module.

7. A display device, comprising:
a plurality of I/O ports;
a plurality of light sources corresponding to the plurality of I/O parts; and
a signal generating device, electrically connected to the plurality of light sources, for generating a state signal;
wherein part of the plurality of light sources is illuminated according to the state signal and thus part of the plurality of I/O ports is indicated to the user correspondingly.

8. The display device of claim 7, wherein when a user selects one of the plurality of I/O ports, the signal generating device generates the state signal and the corresponding part of the plurality of light sources is turned on.

9. The display device of claim 7, further comprising:
an OSD menu generator, for generating an OSD menu on the display device, the OSD menu including an all turn-on option, an individual turn-on option, and an all turn-off option for the plurality of light sources.

10. The display device of claim 7, wherein the plurality of light sources comprises LED modules.

11. The display device of claim 7, further comprising:
a processor, electrically connected to the light source, for controlling the light source.

12. A method of indicating a connection interface of a display device to a user, comprising the steps of:
generating a state signal according to the user;
illuminating a light source of the display device according to the state signal, said light source is located close to the connection interface; and
turning off the light source of the display device.

13. The method in accordance with claim 12, wherein state signal is generated by an input device.

14. The method in accordance with claim 12, wherein the state signal is generated by an object sensor of the display device.

15. The method in accordance with claim 12, wherein the light source of the display device is turned off after a predetermined period of time.

16. The method in accordance with claim 12, wherein the light source of the display device is turned off according to the state signal.

17. The method in accordance with claim 12, wherein the connection interface of the display device comprises a plurality of I/O ports, and the light source of the display device comprises a plurality of lights corresponding to the plurality of I/O ports.

18. The method in accordance with claim 17, wherein the step of illuminating a light source of the display device according to the state signal further includes the step of identifying part of the plurality of I/O ports corresponding to the state signal, and illuminating part of the plurality of lights so the part of the plurality of I/O ports corresponding to the state signal is indicated to the user.

19. The method in accordance with claim 17, wherein the step of illuminating a light source of the display device according to the state signal further includes the step of illuminating a first group of the plurality of lights in a first way to indicate a first group of the plurality of I/O ports to the user.

20. The method in accordance with claim 17, wherein the plurality of lights are separated into a plurality of groups with more than one combination of colors.
